(19) United States
(12) Patent Application Publication
(10) Pub. No.: US 2014/0030462 A1
(43) Pub. Date: Jan. 30, 2014

(54) PROTECTIVE COVERING FOR ELECTRONIC DEVICES HAVING IMPROVED ELASTICITY AND IMPACT RESISTANCE PROPERTIES

(71) Applicant: FLEXcon Company, Inc., Spencer, MA (US)

(72) Inventor: William W. Sullivan, East Douglas, MA (US)

(21) Appl. No.: 13/932,618

(22) Filed: Jul. 1, 2013

Related U.S. Application Data
(60) Provisional application No. 61/666,259, filed on Jun. 29, 2012.

(51) Int. Cl. C09J 7/02

(52) U.S. Cl. CPC C09J 7/0296; C09J 7/0285
USPC 428/41.3; 428/212; 428/423.7; 428/483; 428/480

(57) ABSTRACT

A non-conductive protective covering for an electronic device is disclosed. The protective covering includes a first polymeric film having a modulus of elasticity of at least about 100×10³ psi and a second polymeric film having a modulus of elasticity of less than about 100×10³ psi, wherein the first polymeric film is attached to a first side of the second polymeric film.

### CROSS REFERENCE TO RELATED APPLICATION

This application claims priority from U.S. Provisional Application Ser. No. 61/666,259 filed Jun. 29, 2012, the content of which is incorporated herein in its entirety.

### BACKGROUND

Electronic devices such as smart phones, MP3 players, pads, tablets, GPS devices, etc. are ubiquitous and undergo continuous daily handling by their users. Unfortunately, this use and handling sometimes results in the devices (including any screens on the devices) becoming scratched or worse, cracked or broken altogether.

Protective coverings are useful in limiting any damage done to the displays and other components of the devices. See for example, U.S. Pat. No. 7,957,524, which discloses the use of films of a thermoplastic elastomer or a urethane plastic such as polyether urethane, polyester urethane or aliphatic urethane, that are applied to a device screen or the entire device (as a body cover) using an adhesive, heat bonding or pressure bonding. These protective coverings may have pre-cut shapes to accommodate a specific device, or allow one to cut shapes as needed.

When a pressure sensitive adhesive (PSA) is used, a release liner is generally provided over the pressure sensitive adhesive. During use, the liner is removed and the covering is applied to the device, being careful not to entrap air between the covering and the device. Certain application techniques involve wetting the surface to be protected to prevent the PSA from establishing too strong a bond during application, thus allowing for ease in repositioning the protective covering on the device if needed.

Conventional protective coverings are generally clear thermoplastic polyurethane films, which exhibit high impact absorbing properties, and have excellent scratch or mar resistance. Further, such polymeric films are generally flexible, which has conventionally been considered an advantage is applying the films to the devices.

Over time however, such conventional protective coverings have been found to curl around the edges of the film, and these curled edges may catch on other surfaces with which the device comes into contact, leading to additional displacement of the protective covering.

There is a need, therefore, for an improved protective covering that provides excellent protection yet does not exhibit reduced adhesion to the device over time.

### SUMMARY

In accordance with an embodiment, the invention provides a protective covering for an electronic device, wherein the protective covering includes a first polymeric film having a modulus of elasticity of at least about 100×10³ psi and a second polymeric film having a modulus of elasticity of less than about 100×10³ psi, and wherein the first polymeric film is attached to a first side of the second polymeric film.

In accordance with another embodiment, the invention provides a non-conductive protective covering for an electronic device. The protective covering includes a first polymeric film and a second polymeric film, and the non-conductive protective covering requires at least 500 psi to become elongated outside of an elastic modulus region of the protective covering.

In accordance with a further embodiment, the invention provides a non-conductive protective covering for an electronic device. and the protective covering includes a first polymeric film and a second polymeric film, wherein the protective covering exhibits tear a resistance of between about 6.5 and 7.5 lbf/in, and wherein each of the first and second polymeric films alone exhibits a tear resistance of below about 4 lbf/in.

### BRIEF DESCRIPTION OF THE DRAWINGS

The following description may be further understood with reference to the accompanying drawings in which:

FIG. 1 shows an illustrative diagrammatic view of a protective covering in accordance with an embodiment of the present invention;

FIG. 2 shows an illustrative diagrammatic view of a protective covering in accordance with another embodiment of the present invention;

FIG. 3 shows an illustrative diagrammatic view of a protective covering in accordance with a further embodiment of the present invention; and

FIG. 4 shows an illustrative graphical views of measured tensile stress vs. tensile strain for a polyurethane film for use in a composite of the invention in the machine direction;

FIG. 5 shows an illustrative graphical views of measured tensile stress vs. tensile strain for a polyurethane film for use in a composite of the invention in the transverse direction;

FIG. 6 shows an illustrative graphical views of measured tensile stress vs. tensile strain for a polyester film for use in a composite of the invention in the machine direction;

FIG. 7 shows an illustrative graphical views of measured tensile stress vs. tensile strain for a polyester film for use in a composite of the invention in the transverse direction;

FIG. 8 shows an illustrative graphical views of measured tensile stress vs. tensile strain for a composite of the invention in the machine direction; and

FIG. 9 shows an illustrative graphical views of measured tensile stress vs. tensile strain for a polyurethane film for use in a composite of the invention in the transverse direction.

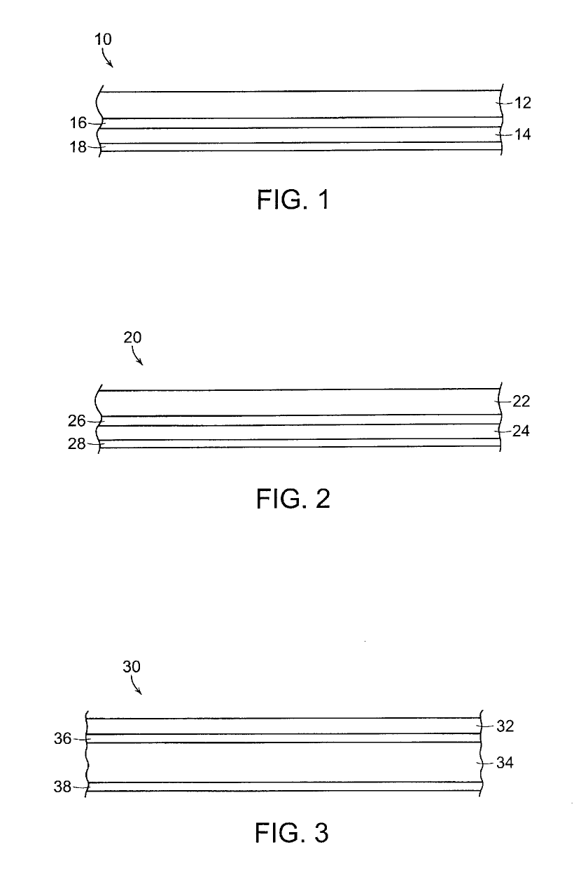

The drawings are shown for illustrative purposes only.

### DETAILED DESCRIPTION

It is known that conventional screen coverings may separate from the device over time at the corners of the coverings, and it is also conventionally known that such coverings should exhibit good flexibility. U.S. Pat. No. 7,957,524, for example, discloses that protective films may have good flexibility and elongation properties of greater than 400%. It has been discovered, however, that while such flexible films may exhibit good impact and scratch resistance, in many cases, it is the flexibility that contributes to the eventual separation of the covering from the device. This is because if a film is stretched (elongated) when applied to a device, or even slightly stretched at a corner during application to a device, the film with seek to return to its original shape after having been applied to the device. This retraction force will eventually overcome the adhesion (e.g., via adhesive or static cling), and cause the undesirable separation of the film from the device.

Films having very low elongation properties (e.g., very low modulus of elasticity) however, also generally have poor impact absorbing properties, which undermines the purpose of using a protective covering.

Applicant has discovered that higher modulus clear film composites for use as protective coverings on electronic devices may be constructed in several difference ways. In accordance with an embodiment, a biaxially orientated polyethylene terephthalate (PET) film (of between about 0.25-6 mil (˜6-150 micron) in thickness) is bonded to a protective polyurethane film with a PSA. A second PSA layer is placed on the opposite side of the PET to act as the bonding adhesive to the electronic device. A silicone coated liner may be used to cover the PSA until final bonding to the electronic device is undertaken. Composites of the invention also preferably do not include any electrically conductive materials.

### EXAMPLE 1

In accordance with a first embodiment 10, a polyurethane film 12 was obtained from Argotec, Inc. of Greenfield, Mass., their product name CLC 93-AV Urethane, at about 6 mil (about 200 microns). A polyethylene tetraphalate (PET) film 14 of about 1 mil (about 25 micron) thickness was then laminated to the polyurethane film 12 using a pressure sensitive adhesive (e.g., the V-63 PSA sold by FLEXcon Company, Inc. of Spencer, Mass.). The thickness of the adhesive layer 16 between the polyurethane and the PET was about 1 mil (about 25 micron), and the thickness of the adhesive layer 18 between the PET and the surface of the electronic device was about 1.5 mil (about 38 microns). The thickness of adhesive layers may vary considerably depending on the specific requirements of a given application.

The PET film may have a modulus of elasticity of at least about 100×10³ pounds per square inch (psi), preferably between about 200×10³ psi to about 1,000×10³ psi, and more preferably between about 400×10³ psi to about 800×10³ psi.

The polyurethane film may have a modulus of elasticity of below about 100×10³ psi, preferably between about 1×10³ psi to about 10×10³ psi, and more preferably between about 2×10³ psi to about 4×10³ psi.

A suitable PET used in this application is a 1 mil (25 micron) material available from SKC, Inc. of Covington, Ga. (under the product name SH 18S). Variations in the thickness of the polyurethane and or PET may be employed as the specific demands of an application is presented, as well as the thickness of the adhesive layers or again, application specific demands, the adhesive itself The final composite should be as clear as possible so as to prevent screen image distortion on the device itself.

The PET layer in the composite functions to resist the elongation of the polyurethane during the application of the composite to the electronic device, it should also be noted that the PSA layers (being viscoelastic in nature) would allow for some interlayer movement, which could provide a mechanism for any minor stress encountered during application to a device to relieve itself without allowing for significant composite displacement.

In a further example of this embodiment, a protective coverings was made using an 8 mil polyurethane film laminated to a 0.95 mil polytetrathalate film using the V-63 PSA (1 mil) discussed above. A further PSA layer (V-63) was provided on the opposite side of the polytetrathalate film at a thickness of 1 mil. The final composite had an overall thickness of 10.95 mil. The modulus of elasticity of the polyurethane film alone was measured to be 2.658×10³ psi in the machine direction and 2.877×10³ psi in the transverse direction, having an overall average of 2.7675×10³ psi. The modulus of elasticity of the polytetrathalate film alone was measured to be 637.771×10³ psi in the machine direction and 727.972×10³ psi in the transverse direction, having an overall average of 682.8715×10³ psi. The modulus of elasticity of the resulting laminated protective covering was measured to be 190.752×10³ psi in the machine direction and 208.516×10³ psi in the transverse direction, having an overall average of 199.634×10³ psi. Tests were conducted in accordance with ASTM D 882-02. As used herein, the term modulus of elasticity may refer to any of machine direction modulus of elasticity, transverse direction modulus of elasticity or overall average modulus of elasticity.

### EXAMPLE 2

In another embodiment of the invention, particularly when it is desired to have a thinner composite, the layer of PSA between the polyurethane and the polyester can be eliminated and substituted with a heat activated adhesive, for example, between about 0.02-1.0 mil (0.5-25 microns). In accordance with this embodiment 20 of the invention, the polyurethane layer 22 may be cast on the polyester (PET) layer 24 directly, dried, cured, etc. on the PET film using a heat activated adhesive 26. The opposite side of the PET layer 24 would include a PSA layer 28 as discussed above. For example a PET film with an adhesion promoting layer such as FLEXcon's Top Coating 840, coated with WF040-357 polyester urethane emulsion available from Stahl USA Inc. of Newark, N.J., would yield a composite similar in structure to that shown in FIG. 2. An advantage is that this construction technique may be employed to more easily obtain a specifically desired urethane thickness.

### EXAMPLE 3

The use of PET as a structural reinforcement to prevent unwanted polyurethane displacement during application to an electronic device has significant advantages. If however, it is not desired to provide the polyester as part of the final protective film composite, as it may add too much stiffness to the composite, there is still a further way to have the advantages of the high modulus PET film during affixing the protective covering to the electronic devise and easily removing it from the devise once a stable bond has been achieved between the polyurethane film and the device.

As shown in FIG. 3, an embodiment 30 of the invention includes a PET film 32 that is applied to a polyurethane film 34 using a low peel strength adhesive 36. This embodiment provides a PET film with a removable adhesive coated on the side to be affixed to the polyurethane. The opposite side of the polyurethane layer 34 includes a PSA layer 38 as discussed above.

This adhesive 36, such as FLEXcon's V-302 ULP, is designed to have a low bond strength (less than 4 oz/inch width PSTC #1) but has resistance to a shearing force. Thus a polyurethane film with the bonding adhesive 38 may be applied to a device together with the PET film laminated to the polyurethane film (using V-302 ULP) on the opposite side of the polyurethane film.

This composite will allow the placement of the polyurethane protective film to the device without the problems of having the polyurethane moiety distort or elongate, and the PET film may then be cleanly removed from the polyurethane film again without distorting or elongating the polyurethane film. Some polyurethane films, when placed in contact with a PET film under heat and pressure may form a sufficient static-type bond to be useful in this embodiment of the invention, thus eliminating the need for the V-302 ULP or like low bonding adhesive.

While specific adhesives mentioned above will function in defined manner, other adhesives from FLEXcon or other suppliers may function equally as well depending upon the specific surfaces being bonded and other environmental circumstances specified to the final product.

Further, while polyurethane films meet the requirements for use as a protective covering for electronic devices it is not the only material which could work. Plasticized PVC and polyvinyl butyrals may also find application in this area as well may other clear, impact resistant polymeric materials. The teachings of the invention disclosed here is applicable to all such variations.

Further, other high modulus films such as polycarbonates, high molecular weight, linear polyethylene's, etc., could substitute for the PET within the spirit of this invention.

Table 1 below shows handle testing results for a composite that includes a clear polyurethane film (CD U 600 Clear), and polyethylene terephthalate film (FLEXMARK PM 100 Clear) with an acrylic pressure sensitive adhesive (V-63) on either side of the PET film.

In short:

| FILM: 9419W3 60.50000 001321 CD U 600 CLEAR | |
|---|---|
| ADHESIVE: 1326ML-5(1.00-1.10) | V-63, A-405, A-198 |
| FILM: 5822W1 60.50000 FLEXMARK PM 100 CLEAR, | |
| FLEXMARK OM 100 CL | |
| ADHESIVE: 1326ML-5(1.40-1.50) | V-63, A-405, A-198 |

LINER: 3842W2 61.00000 01563A 300 MATTE C1S

TABLE 1

| | Film: 9419W3 | File: | Workorder |
|---|---|---|---|
| | CD U Clear | 5822W1 | 2017046-002 |
| | (film comes with a | FLEXMARK | (Liner stock 3842W2 was removed prior |
| | protective cap that was | PM 100 | to testing. The protective cap on stock |
| | removed for testing) | Clear | 9419W3 was also removed prior to testing) |
| Caliper (mils) | 6.0 | .95 | 10.10 |
| Modulus (psi) | 3,995 | 613,938 | 58,873 |
| MD | | | |
| Modulus (psi) | 3,803 | 709,380 | 59,574 |
| MD | | | |
| Handle 6 × 6″ | 16.0 | 6.2 | 95.2 |
| grams side 1 MD | | | |
| Handle 6 × 6″ | 23.4 | 5.5 | 96.3 |
| grams side 2 MD | | | |
| Handle 6 × 6″ | 17.8 | 6.1 | 93.1 |
| grams side 1 TD | | | |
| Handle 6 × 6″ | 20.2 | 5.7 | 97.7 |
| grams side 2 TD | | | |
| Handle 6 × 6″ | 19.35 | 5.9 | 95.6 |
| grams Average | | | |

Modulus testing was done at a test speed of 1 inch/min, as specified by the ASTM D882 standard for testing modulus. The grip separation was 4 inches and the samples were 1 inch wide strips. No grip slippage was observed in any of the tests using the 1 kN pnumatic grips with rubber coated faces. Testing was conducted with controlled temperature/humidity. Testing was stopped manually prior to failure after it was clear that the test had proceeded past the yield point of each material (the test was allowed to run significantly past the yield on the first specimen of each material tested to ensure the yield the process was past the yield). Five test specimens were tested in each direction with the average results reported in the table above

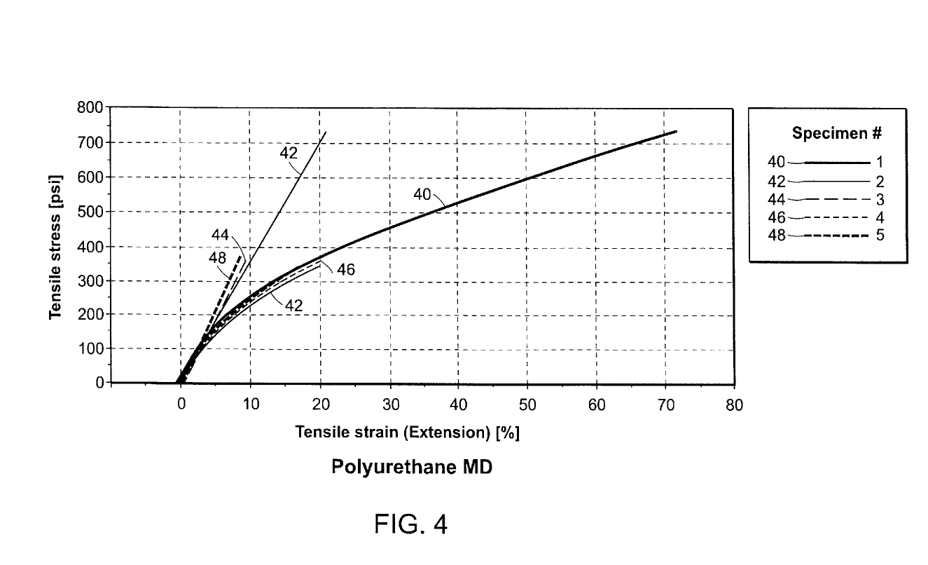

Table 2 below show tensile stress versus tensile strain in the machine direction for a polyurethane film for use in a composite of the present invention (with Test conditions: 4″ grip separation, 1″/min test speed and Sample width 1″). The results for the five specimens are shown at 40-48 in FIG. 4.

Urethane MD: stock 9419w3

TABLE 2

| | | Modulus |
|---|---|---|
| | | (Automatic Young's) |
| | Specimen label | [psi] |
| 1 | 9419W3 Urethane MD | 3,374 |
| 2 | 9419W3 Urethane MD | 3,954 |
| 3 | 9419W3 Urethane MD | 4,028 |
| 4 | 9419W3 Urethane MD | 4,352 |
| 5 | 9419W3 Urethane MD | 4,269 |
| Mean | | 3,995 |
| Standard Deviation | | 384.2 |

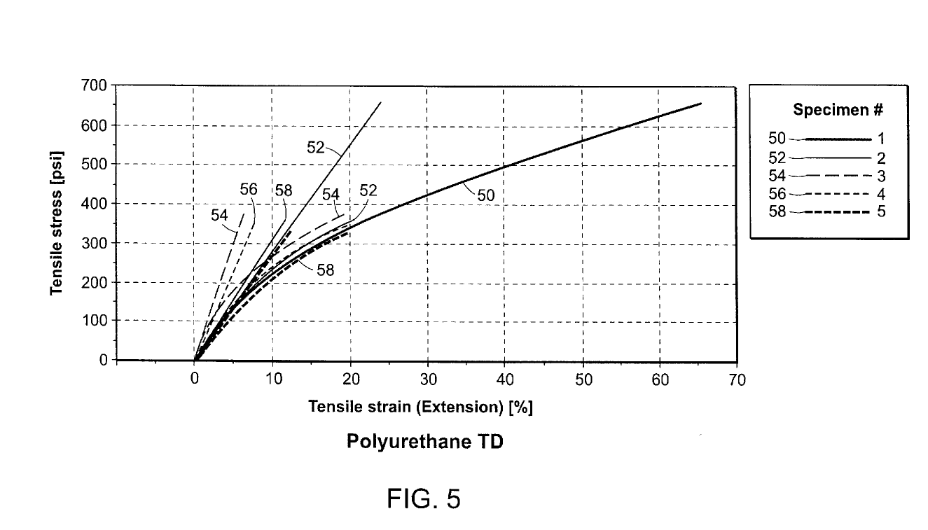

Table 3 below show tensile stress versus tensile strain in the transverse direction for a polyurethane film for use in a composite of the present invention (with Test conditions: 4″ grip separation, 1″/min test speed and Sample width 1″). The results for the five specimens are shown at 50-58 in FIG. 5.

Urethane TD: stock 9419w3

TABLE 3

| | | Modulus |
|---|---|---|
| | | (Automatic Young's) |
| | Specimen label | [psi] |
| 1 | 9419W3 Urethane TD | 2,722 |
| 2 | 9419W3 Urethane TD | 3,072 |
| 3 | 9419W3 Urethane TD | 5,826 |
| 4 | 9419W3 Urethane TD | 4,670 |
| 5 | 9419W3 Urethane TD | 2,722 |
| Mean | | 3,803 |
| Standard deviation | | 1,388.9 |

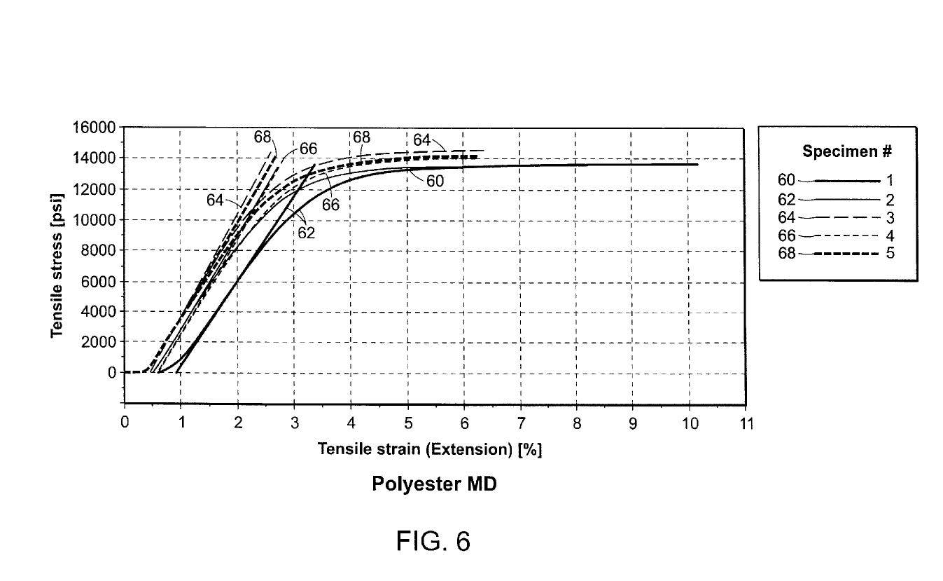

Table 4 below show tensile stress versus tensile strain in the machine direction for a polyester film for use in a composite of the present invention (with Test conditions: 4″ grip separation, 1″/min test speed and Sample width 1″). The results for the five specimens are shown at 60-68 in FIG. 6.

Polyester MD: stock 5822w1

TABLE 4

| | | Modulus |
|---|---|---|
| | | (Automatic Young's) |
| | Specimen label | [psi] |
| 1 | 5822W1 Polyester MD | 552,500 |
| 2 | 5822W1 Polyester MD | 608,463 |
| 3 | 5822W1 Polyester MD | 661,871 |
| 4 | 5822W1 Polyester MD | 628,077 |
| 5 | 5822W1 Polyester MD | 618,777 |
| Mean | | 613,938 |
| Standard deviation | | 39,766.5 |

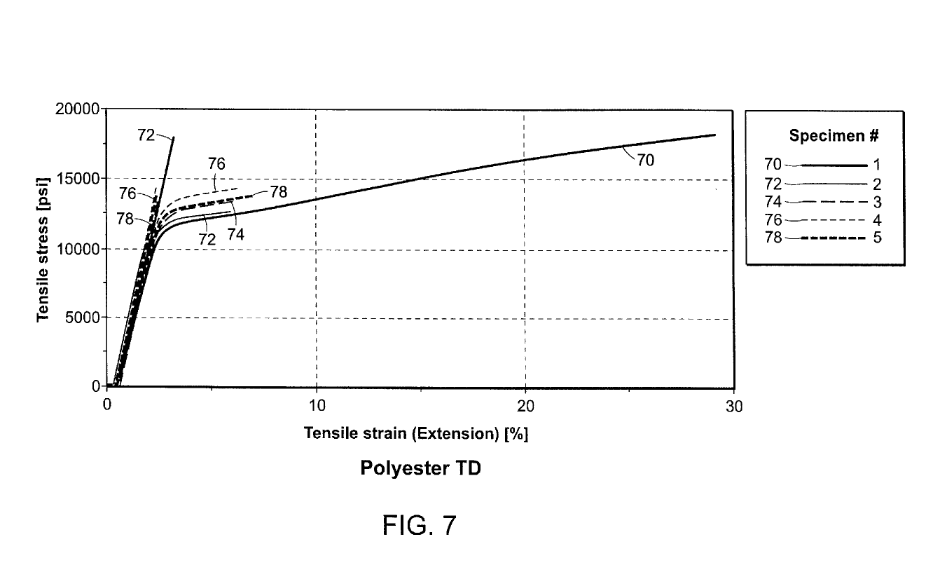

Table 5 below show tensile stress versus tensile strain in the transverse direction for a polyester film for use in a composite of the present invention (with Test conditions: 4″ grip separation, 1″/min test speed and Sample width 1″). The results for the five specimens are shown at 70-78 in FIG. 7.

Polyester TD: stock 5822w1

TABLE 5

| | | Modulus |
|---|---|---|
| | | (Automatic Young's) |
| | Specimen label | [psi] |
| 1 | 5822W1 Polyester TD | 659,294 |
| 2 | 5822W1 Polyester TD | 691,501 |
| 3 | 5822W1 Polyester TD | 726,683 |
| 4 | 5822W1 Polyester TD | 738,120 |
| 5 | 5822W1 Polyester TD | 731,300 |
| Mean | | 709,380 |
| Standard deviation | | 33,294.6 |

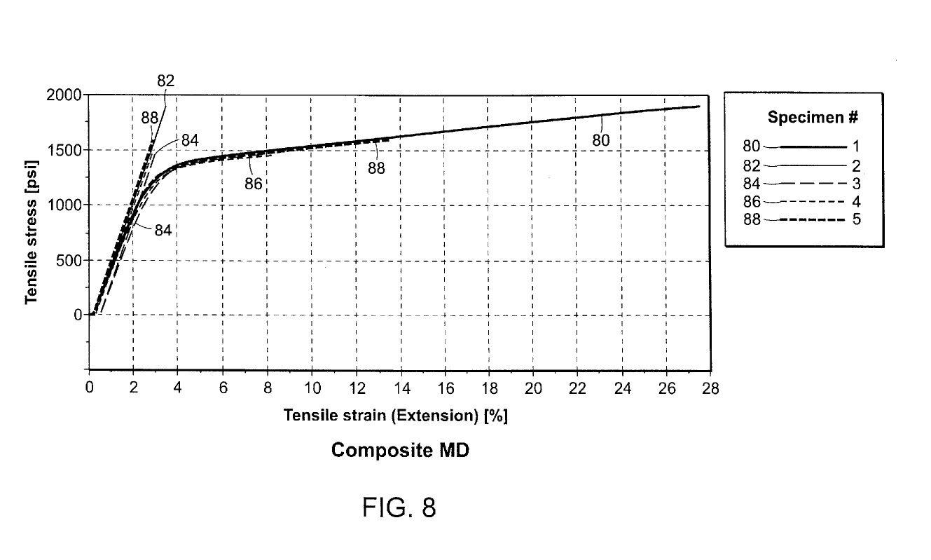

Table 6 below show tensile stress versus tensile strain in the machine direction for a composite of the present invention (with Test conditions: 4″ grip separation, 1″/min test speed and Sample width 1″). The results for the five specimens are shown at 80-88 in FIG. 8.

### Composite MD:

TABLE 6

| | | Modulus |
|---|---|---|
| | | (Automatic Young's) |
| | Specimen label | [psi] |
| 1 | WO 2017046-002 MD | 58,459 |
| 2 | WO 2017046-002 MD | 58,411 |
| 3 | WO 2017046-002 MD | 59,259 |
| 4 | WO 2017046-002 MD | 58,832 |
| 5 | WO 2017046-002 MD | 59,402 |
| Mean | | 58,873 |
| Standard deviation | | 451.3 |

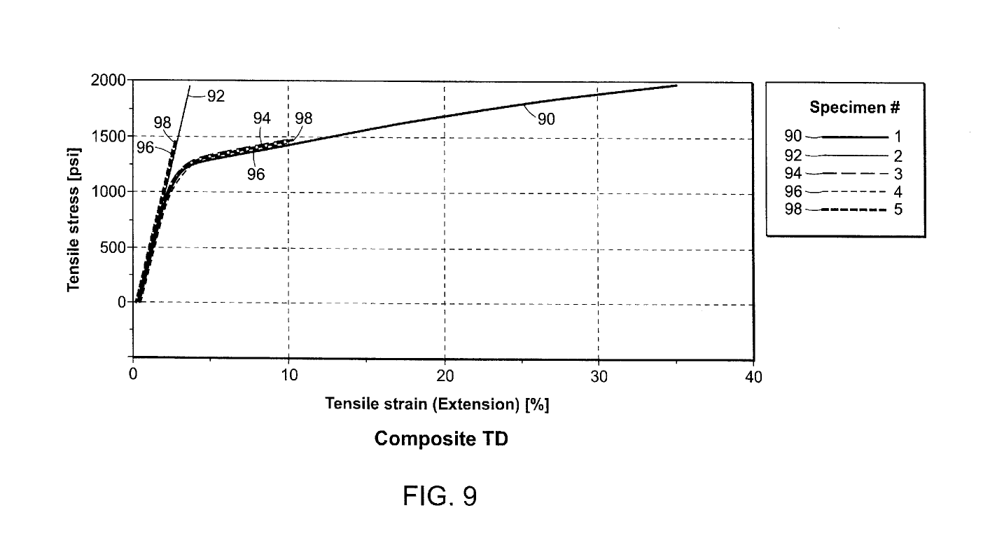

Table 7 below show tensile stress versus tensile strain in the transverse direction for a composite of the present invention (with Test conditions: 4″ grip separation, 1″/min test speed and Sample width 1″). The results for the five specimens are shown at 90-98 in FIG. 9.

### Composite TD:

TABLE 7

| | | Modulus |
|---|---|---|
| | | (Automatic Young's) |
| | Specimen label | [psi] |
| 1 | WO 2017046-002 TD | 58,527 |
| 2 | WO 2017046-002 TD | 58,440 |
| 3 | WO 2017046-002 TD | 60,710 |
| 4 | WO 2017046-002 TD | 60,095 |
| 5 | WO 2017046-002 TD | 60,098 |
| Mean | | 59,574 |
| Standard deviation | | 1,027.2 |

As may be seen from FIGS. 4-9, the stress/strain point at which the films and composites become stretched beyond their elastic modulus region (the linear portion of each of FIGS. 4-9) is significantly improved for the composite (FIGS. 8 and 9) over that of the polyurethane alone (FIGS. 4 and 5). In fact, the urethane film alone exhibited very little such range in the transverse direction (FIG. 5). In accordance with an embodiment (and with reference to FIGS. 8 and 9), composites of the invention may require at least 500 psi and preferably even up to 1000 psi in order to become elongated outside of their elastic modulus region. Further, such composites may be stretched at least 1% and preferably even up to 2% without having been stretched beyond the elastic modulus region.

Table 8 below shows optical properties of a composite of the invention.

TABLE 8

| | Composite |
|---|---|
| | (Liner stock 3842W2 was removed prior to |
| | testing, and the protective cap on stock |
| | 9419W3 was also removed prior to testing) |
| 60 degree gloss: gu | 107 |
| % Haze | 11.4 |
| % TLT | 92.9 |
| % Clarity | 54.8 |
| Applied Haze - Immediate | 6.15 |
| Applied Haze -24 hours | 3.57 |

Table 9 shows below peel tests for composites of the present invention.

TABLE 9

| | Composite |
|---|---|
| | (Liner stock 3842W2 was removed prior to |
| | testing, and the protective cap on stock |
| | 9419W3 was also removed prior to testing) |
| 15 Minute peels on s.s. | 911(0), 905(0) |
| panel | |
| 24 Hour peels on s.s. | 2076(0), 2342(0) |
| panel | |

Table 10 below shows coefficient of friction (COF) testing of a composite of the invention on a release machine using ASTM D1894-01 (180° at 6″/min.).

### COF (Release tester)

### Face of Urethane against Smooth Side of 455 g Weight

TABLE 10

| | Static COF (g) | Kinetic COF (g) |
|---|---|---|
| Measurements | 531, 559, 727 | 415, 446, 533 |
| Average | 606 | 465 |
| COF | 2.49 | 1,022. |

Composites of the invention may therefor exhibit coefficients of friction of about 3.5 to 4.5 lbs, and preferably about 4.

The results of tear resistance testing of a composite of the invention is shown in Tables 11-15 below. In particular, Table 11 shows the results of propagated tear testing (ASTM D 1938 (08.01) (1×3″ MD and TD).

TABLE 11

| | | | | | | Average | Average |
|---|---|---|---|---|---|---|---|
| | Sample 1 | Sample 2 | Sample 3 | Sample 4 | Sample 5 | (lbs). | (grams) |
| MD | 3.91567 | 3.88547 | 4.04294 | 4.37660 | 3.72640 | 3.98942 | 1811.20 |
| TD | 4.03730 | 3.33412 | 4.16940 | 4.26881 | 3.78386 | 3.91870 | 1779.09 |

Table 12 below shows the results of propagated tear testing of the polyurethane and PET films separately.

TABLE 12

| | | | | | | Average | Average |
|---|---|---|---|---|---|---|---|
| | Sample 1 | Sample 2 | Sample 3 | Sample 4 | Sample 5 | (lbs). | (grams) |
| Urethane | 1.44015 | 1.44731 | 1.42707 | 1.53613 | 1.43109 | 1.45635 | 661.18 |
| MD | | | | | | | |
| Urethane | 1.58880 | 1.58171 | 1.58534 | 1.64983 | 1.40846 | 1.56283 | 709.52 |
| TD | | | | | | | |
| PET | 0.02351 | 0.02423 | 0.02598 | 0.02716 | 0.02616 | 0.02541 | 11.536 |
| MD | | | | | | | |
| PET | 0.01989 | 0.02831 | 0.02541 | 0.02645 | 0.02944 | 0.02572 | 11.676 |
| TD | | | | | | | |

Table 13 below shows Graves tear (initiation) results for urethane films, PET films and composites of the invention in accordance with ASTM D1004.

TABLE 13

| | | | | | | | | | Ave. |
|---|---|---|---|---|---|---|---|---|---|
| | | | | | | Avg. | Ave. | Std. Dev. | Caliper |
| | 1 | 2 | 3 | 4 | 5 | (lbf/in) | (grams) | (lbf | (mils) |
| Urethane | 3.562 | 3.585 | 3.591 | 3.805 | 3.710 | 3.643 | 1652.4 | 0.11260 | 6.040 |
| MD | | | | | | | | | |
| Urethane | 3.408 | 3.452 | 3.491 | 3.684 | 4.169 | 3.641 | 1651.5 | 0.31376 | 6.080 |
| TD | | | | | | | | | |
| PET | 3.107 | 2.484 | 4.145 | 3.187 | 3.010 | 3.187 | 1445.6 | 0.60198 | 0.95 |
| MD | | | | | | | | | |
| PET | 4.139 | 3.433 | 2.396 | 2.821 | 3.722 | 3.302 | 1497.8 | 0.6772 | 0.95 |
| TD | | | | | | | | | |
| Composite | 7.188 | 6.433 | 6.533 | 6.705 | 7.959 | 6.963 | 3158.49 | 0.62760 | 10.10 |
| MD | | | | | | | | | |
| Composite | 8.234 | 7.651 | 6.825 | 7.661 | 6.449 | 7.364 | 3340.3 | 071692 | 10.10 |
| TD | | | | | | | | | |

The maximum extension (in inches) for the urethane in the machine direction and transverse direction were 2.013 and 1.939 respectively, and the maximum extension (in inches) for the PET in the machine direction and transverse direction were 0.264 and 0.261 respectively. The maximum extension (in inches) for the composite in the machine direction and transverse direction were 0.927 and 1.005 respectively.

Composites of the present invention may therefore exhibit tear resistance of between about 6.5 and 7.5 lbf/in preferably about 7 lbf/in, while each of the polyurethane and polyester films alone exhibits a tear resistance of below about 4 lbf/in.

Those skilled in the art will appreciate that numerous modifications and variations may be made to the above disclosed embodiments without departing from the spirit and scope of the present invention.

What is claimed is:

1. A non-conductive protective covering for an electronic device, said protective covering comprising a first polymeric film having a modulus of elasticity of at least about 100×10³ psi and a second polymeric film having a modulus of elasticity of less than about 100×10³ psi, wherein said first polymeric film is attached to a first side of said second polymeric film.

2. The protective covering as claimed in claim 1, wherein said protective covering includes a first adhesive on a second side of said second polymeric film that is opposite the first side of the second polymeric film.

3. The protective covering as claimed in claim 2, wherein said first adhesive is a pressure sensitive adhesive.

4. The protective covering as claimed in claim 2, wherein said protective covering includes a second adhesive that bonds the first polymeric film to the second polymeric film.

5. The protective covering as claimed in claim 4, wherein said second adhesive is a pressure sensitive adhesive.

6. The protective covering as claimed in claim 4, wherein said second adhesive is a heat activated adhesive.

7. The protective covering as claimed in claim 1, wherein said protective covering includes a first adhesive on said second polymeric film on a surface that is opposite said first polymeric film, and wherein first polymeric film and said second polymeric film are bonded together with a low peel adhesive such that said first polymeric film may be separated from said second polymeric film following application of the protective covering to the electronic device.

8. The protective covering as claimed in claim 1, wherein said first polymeric film is biaxially oriented polyethylene tetraphalate.

9. The protective covering as claimed in claim 1, wherein said second polymeric film is a polyurethane.

10. The protective covering as claimed in claim 1, wherein said second polymeric film is comprised of plasticized polyvinyl chloride.

11. The protective covering as claimed in claim 1, wherein said second polymeric film is comprised of a polyvinyl butyral.

12. The protective covering as claimed in claim 1, wherein said first polymeric film has a modulus of elasticity of between about 200×10³ psi and about 1,000×10³ psi.

13. The protective covering as claimed in claim 1, wherein said first polymeric film has a modulus of elasticity of between about 400×10³ psi and about 800×10³ psi.

14. The protective covering as claimed in claim 1, wherein said second polymeric film has a modulus of elasticity of between about 1×10³ psi and about 10×10³ psi.

15. The protective covering as claimed in claim 1, wherein said second polymeric film has a modulus of elasticity of between about 2×10³ psi and about 4×10³ psi.

16. The protective covering as claimed in claim 1, wherein said protective covering has a modulus of elasticity of at least about 100×10³ psi.

17. The protective covering as claimed in claim 1, wherein said protective covering has a modulus of elasticity of at least about 200×10³ psi.

18. A non-conductive protective covering for an electronic device, said protective covering comprising a first polymeric film and a second polymeric film, wherein said non-conductive protective covering requires at least 500 psi to become elongated outside of an elastic modulus region of said protective covering.

19. The protective covering as claimed in claim 18, wherein said non-conductive protective covering requires at least 1,000 psi to become elongated outside of an elastic modulus region of said protective covering.

20. A non-conductive protective covering for an electronic device, said protective covering comprising a first polymeric film and a second polymeric film, wherein the protective covering exhibits tear resistance of between about 6.5 and 7.5 lbf/in, and wherein each of the first and second polymeric films alone exhibits a tear resistance of below about 4 lbf/in.
